(19) United States
(12) Patent Application Publication
(10) Pub. No.: US 2023/0308260 A1
(43) Pub. Date: Sep. 28, 2023

(54) Apparatus for Receiving Cryptographically Protected Communication Data and Method for Receiving Cryptographically Protected Communication Data

(71) Applicant: Siemens Aktiengesellschaft, München (DE)

(72) Inventor: Rainer Falk, Poing (DE)

(73) Assignee: Siemens Aktiengesellschaft, München (DE)

(21) Appl. No.: 18/188,071

(22) Filed: Mar. 22, 2023

(30) Foreign Application Priority Data
Mar. 24, 2022 (EP) 22164098.0

(51) Int. Cl. H04L 9/08; H04L 9/06

(52) U.S. Cl. CPC H04L 9/0819; H04L 9/0618; H04L 9/0861

(57) ABSTRACT

Various embodiments of the teachings herein include an apparatus for receiving cryptographically protected communication data. In some examples, the apparatus includes: a key generator for generating session keys; a receive module with a signal link to the key generator and configured to receive and decrypt cryptographically protected communication data into plaintext information using the session keys; and a check module with a signal link to the receive module and configured to subject the plaintext information to a check for context information characterizing a communication context of the encrypted communication data. The apparatus restricts action of the receive module depending on a result of the check.

### CROSS-REFERENCE TO RELATED APPLICATIONS

This application claims priority to EP Application No. 22164098.0 filed Mar. 24, 2022, the contents of which are hereby incorporated by reference in their entirety.

### TECHNICAL FIELD

The present disclosure relates to communication. Various embodiments include apparatus and/or methods for receiving cryptographically protected communication data.

### BACKGROUND

In encryption devices for receiving cryptographically protected communication data, for example in a hardware security module, a plurality of components are typically used. These include key generators, for instance crypto-controllers, also generally known as a secure element, which although available as particularly highly protected hardware components have only a relatively low processing power. Therefore they are often used only for secure storage of long-term keys and for authenticating and providing session keys. For the actual encryption operations with high performance demands, for instance high data-throughput or high jitter or large transmission delay, separate crypto-components are used known as high-speed crypto-engines, i.e. high-speed encryption modules or high-speed decryption modules, which in practice, however, do not achieve the same high level of protection as a key generator. The high-speed decryption modules or high-speed encryption modules are provided with a session key generated by a key generator, i.e. a cryptographic key which has a relatively short validity period, for instance a validity period of one hour, 8 hours or 24 hours, or is limited to decrypting or encrypting a predefined limited data volume.

### SUMMARY

There is a need for apparatus and methods in which the unauthorized use of provided session keys can be prevented. In particular, an apparatus and a method shall be defined that hamper or thwart attacks in which an attacker is attempting to gain access to a session key that can be provided by a key generator via a communication interface. The teachings of the present disclosure include correspondingly improved apparatus and methods for receiving cryptographically protected communication data.

For example, some embodiments include an apparatus for receiving cryptographically protected communication data, having a key generator (CC) for generating session keys, and a receive module (HSCE), which has a signal link to the key generator and is designed to receive and decrypt cryptographically protected communication data into plaintext information (ECD) by means of session keys generated and transferred by the key generator (CC), and having a check module (CDP), which has a signal link to the receive module (HSCE) and is designed to subject the plaintext information (ECD) to a check for context information characterizing a communication context of the encrypted communication data, which apparatus is configured to restrict the receiving or the decryption depending on a result of the check.

In some embodiments, the communication context is dependent on the session key or assigned to the session key, in particular is a communication context in the form of a communication add-on, preferably a digital watermark.

In some embodiments, the apparatus is designed to transfer a portion of the plaintext information (ECD) to the check module (CDP), and the check module (CDP) is designed to subject the plaintext information (ECD) to the check in such a way that the check module (CDP) subjects the portion of the plaintext information (ECD) to the check.

In some embodiments, the context information comprises information about a usage time period, or identification information from sender and/or receiver, and/or a format of the cryptographic communication data and/or of the plaintext information (ECD), and/or compliance of the plaintext information (ECD) with a protocol, in particular with a safety protocol, and/or a validity of a time stamp or of a check value, in particular of a CRC check value.

In some embodiments, the context information comprises a watermark, in particular a cryptographically protected watermark.

In some embodiments, the context information comprises at least one checksum.

In some embodiments, the apparatus is additionally designed to encrypt send-information into encrypted send-data by means of session keys generated and transferred by the session key generator, wherein the apparatus is designed to check the encryption of the send-data by means of session keys.

In some embodiments, the apparatus is a mobile radio device (HSM).

In some embodiments, the apparatus is an industrial IoT device (HSM), in particular a control device, designed to receive encrypted communication data in the form of control information and/or safety protocol information.

As another example, some embodiments include a method for receiving cryptographically protected communication data by means of a key generator (CC) for generating session keys, and by means of a receive module (HSCE), which has a signal link to the key generator and is designed to receive and decrypt cryptographically protected communication data into plaintext information (ECD) by means of session keys generated and transferred by the key generator, wherein the plaintext information (ECD) is subjected to a check for context information characterizing a communication context of the encrypted communication data, and the receiving or the decryption is restricted depending on a result of the check.

In some embodiments, the method is performed by an apparatus (HSM) as described herein.

### BRIEF DESCRIPTION OF THE DRAWINGS

The teachings herein are explained in more detail below with the aid of an exemplary embodiment illustrated in the drawing, in which:

FIG. 1 shows schematically in a block diagram a first exemplary embodiment of an apparatus incorporating teachings of the present disclosure for receiving cryptographically protected communication data; and

FIG. 2 shows schematically in a block diagram a second exemplary embodiment of an apparatus incorporating teachings of the present disclosure for receiving cryptographically protected communication data.

### DETAILED DESCRIPTION

Various embodiments of the teachings herein include an apparatus according used to receive cryptographically protected communication data and has a key generator for generating session keys, and a receive module, which has a signal link to the key generator and is designed to receive and decrypt cryptographically protected communication data into plaintext information by means of session keys generated and transferred by the key generator. The apparatus also has a check module, which has a signal link to the receive module and is designed to subject the plaintext information to a check for context information characterizing a communication context of the encrypted communication data. The apparatus according to the invention is preferably configured to restrict the receiving or the decryption depending on a result of the check.

The apparatus described herein can be used advantageously to check whether plaintext has actually been decrypted in the intended manner. The check of the plaintext information for context information that characterizes a communication context of the encrypted communication can be used to check a plausibility of the plaintext and thus to check with high probability also a decryption of the encrypted communication data using the applicable session key. Hence the security in the use of apparatuses for receiving cryptographically protected communication data which have a key generator for generating session keys, and a receive module, which has a signal link to the key generator, is significantly increased and in particular is better protected against tampering. In the case of the apparatus according to the invention, attackers would not only have to gain access to a signal link between receive module and key generator, but attackers must in addition also plausibly mimic the communication context of the plaintext information. The obstacles to undetected tampering with the apparatus are now greater in number and also interrelated, which means that the security of the apparatus according to the invention is significantly higher than in previously known apparatuses.

In some embodiments, the communication context is dependent on the session key or assigned to the session key, in particular as a communication add-on, e.g. in the form of a digital watermark. It can thereby easily be ensured according to the invention that the plaintext information has actually been decrypted using the session key generated in the intended manner, i.e. using the authentic session key.

In some embodiments, the communication add-on is a cryptographically protected add-on, for instance a digital cryptographically protected watermark. In some embodiments, the apparatus thereby has a particularly tamper-secure design, because it is particularly difficult to tamper with the session key as a result of the cryptographically protected communication add-on. This is because attackers not only need access to a signal link between receive module and key generator, but in addition attackers must also tamper with the cryptographically protected communication add-on, verifiable from the plaintext information, for example must replicate a cryptographically valid or plausible communication add-on. Thus according to the invention, the effort by attackers, and consequently the level of protection of the apparatus to tampering, is increased significantly.

In some embodiments, the apparatus is designed to transfer a portion of the plaintext information to the check module, and the check module is expediently designed to subject the plaintext information to a check in such a way that it subjects the portion of the plaintext information to the check. Advantageously there is no need in this development to subject the entire plaintext information to a check, but instead it is generally sufficient to verify the plausibility of a portion of the plaintext information. For example, the portion of the plaintext information is a communication add-on, which is checked for correct decryption by the session key. Hence in particular add-on information can be introduced into the plaintext information that can be decrypted in the intended manner only by means of the authentic session key. Thus the plausibility of the decryption by the authentic session key can be verified easily by means of correct decryption of the communication add-on.

In some embodiments, the context information comprises information about a usage time period, or identification information from sender and/or receiver, and/or a format of the cryptographic communication data and/or of the plaintext information, and/or compliance of the plaintext information with a protocol, in particular with a safety protocol, and/or a validity of a time stamp or of a check value, in particular of a CRC check value.

Advantageously, authenticity of the plaintext information and hence also authenticity of the session key can be verified easily by means of the plaintext information, as described above. For example, identification information from sender and/or receiver can be compared with an intended sender identity or receiver identity. If communication data is expected from a specific sender, and if the plaintext information contains identification information precisely from this specific sender, then the plaintext data and hence indirectly also the session key can be classified as trustworthy. Said identification information comprises in particular a digital signature of the sender. Advantageously, a compliance check for compliance of the plaintext information with a protocol allows a positive outcome from the plausibility check when actually obtained plaintext information satisfies a defined, previously agreed protocol. Such a protocol can be in particular a safety protocol if the given communication context intends, or makes likely, a safety protocol. In addition, a time stamp or check value of a portion of the plaintext, in particular a CRC check value, can be used suitably to check the plaintext.

In some embodiments, in the case of the apparatus, the context information comprises a watermark, in particular a cryptographically protected watermark. It is possible to check the plaintext particularly reliably by means of such context information. This is because for context information in the form of a watermark, in particular a cryptographically protected watermark, tampering with the communication of the apparatus would have to comprise not only tampering successfully with a signal link between key generator and receive module, but also the context information in the form of the watermark would have to be tampered with successfully as well. This additional requirement advantageously forms a particularly large obstacle to tampering with the device.

In some embodiments, the context information comprises at least one item of check data. In particular, it is especially difficult to tamper with check data such as scatter values and/or hash values. The apparatus can thereby be designed to be particularly tamper-proof.

In some embodiments, the apparatus is additionally designed to encrypt send-information into encrypted send-data by means of session keys generated and transferred by the session key generator. In some embodiments, the apparatus is also designed to check the encryption of the send-data by means of session keys.

In some embodiments, the apparatus is an apparatus not only for receiving but also for sending encrypted communication data. The encryption of the send-data can be checked, for example, by adding control information into the send-data and subsequently checking the encrypted send-data with regard to the control information. In some embodiments, the apparatus is configured to encrypt in addition control information instead of send-data, and to check the encrypted control information for the intended encryption of the control information by means of the intended session key.

In some embodiments, the apparatus is a mobile radio device, in particular for a terrestrial or satellite-based mobile radio system. In particular in the case of mobile radio devices, tamper-proof communication is a central function, which can be guaranteed particularly reliably according to the invention. In particular, the mobile radio device can be designed to receive encrypted communication data or encrypted communication signals from the mobile radio system.

In some embodiments, the apparatus is an industrial IoT device, in particular a control device, and is designed to receive encrypted communication data in the form of control information.

In some embodiments, a method incorporating teachings of the present disclosure is a method for receiving cryptographically protected communication data by means of a key generator for generating session keys and by means of a receive module, which has a signal link to the key generator. In some embodiments, the receive module is designed to receive and decrypt cryptographically protected communication data into plaintext information by means of session keys generated and transferred by the key generator. In some embodiments, the plaintext information is subjected to a check for context information characterizing a communication context of the encrypted communication data, and the receiving or the decryption is restricted depending on a result of the check. The same advantages as already described for the apparatus incorporating teachings of the present disclosure can also be achieved by the methods described herein.

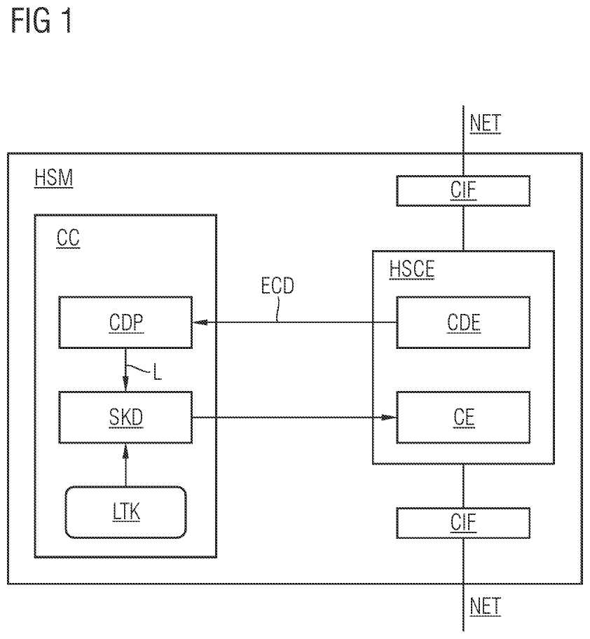

In the exemplary embodiment shown in FIG. 1, an encryption apparatus HSM in the form of a hardware security module is used. The encryption apparatus HSM is a mobile radio device, specifically, in the exemplary embodiment shown, an industrial IoT device (IoT=“Internet of Things”), which is integrated by means of mobile radio into an automation network and forms an industrial control device, or a module of an IoT device or of an industrial control device. The encryption apparatus HSM comprises a session key generator CC in the form of a crypto-controller, which uses a long-term key LTK in order to produce, by means of a module SKD for defining a session key, a session key with the aid of the long-term key. The module SKD for defining a session key transfers the session key to a cryptography module CE of a high-speed decryption module HSCE.

The session key is here a cryptographic key which is formed using at least the long-term key LTK, in the exemplary embodiment shown by key derivation or by an authentication and key-agreement protocol. In the exemplary embodiment shown, the session key generator CC is provided only after successful user authentication, in this case by entering a boot password. In further exemplary embodiments (not shown), user authentication can also be performed by entering a PIN or by means of biometric authentication, optionally additionally including monitoring of tamper sensors, or of an enclosure switch. Further exemplary embodiments (not shown specifically), which otherwise correspond to the exemplary embodiment shown, can also dispense with user authentication.

The session key generator CC is implemented in the exemplary embodiment shown in a manner known per se as a secure element, i.e. as a dedicated security chip. In further exemplary embodiments (not shown specifically), however, the session key generator CC can also be implemented in firmware in a trusted execution environment, for instance as an ARM TrustZone, or as an Intel SGX of a processor, or as a separate core of an IC/ASIC/SoC having a plurality of cores, or as software in obfuscated form, or as a management engine of a processor, or as one or more ASICs.

Encrypted data from a network NET is transferred to the high-speed decryption module HSCE by means of a communication interface CIF, and, after being decrypted, is returned as decrypted data in the form of plaintext to the network NET by means of a further communication interface CIF. In order to decrypt the encrypted data, the cryptography module CE uses the session key obtained from the module SKD for defining a session key of the session key generator CC.

The decrypted data, i.e. the plaintext, is transferred to a plaintext data extractor CDE, which extracts a portion ECD of the plaintext from the plaintext. This portion ECD of the plaintext is transferred to a plaintext plausibility-verification unit CDP in the session key generator CC. The plaintext plausibility-verification unit CDP now checks the portion of the plaintext ECD to ascertain whether the plaintext has actually been produced from the encrypted data using the session key generated previously by the module SKD for defining a session key, or whether the plaintext has been obtained in another way, for instance using an unauthorized session key. The details of the check by the plaintext plausibility-verification unit CDP in the session key generator CC are explained later.

The check by the plaintext plausibility-verification unit CDP then results in a binary check result: either confirmation that the plaintext has been generated using a session key of the module SKD for determining a session key, or refutation that the plaintext has been generated using the module SKD for determining a session key. In the first case, the decryption by the high-speed decryption module HSCE is carried out as intended, and the operation of the encryption apparatus HSM continues unchanged. If, however, a refutation is made, then the module SKD for defining a session key is locked, so that no further session keys can be produced from the long-term key LTK by the module SKD for defining a session key. Hence the high-speed decryption module HSCE is also unable to perform any further decryption of encrypted data.

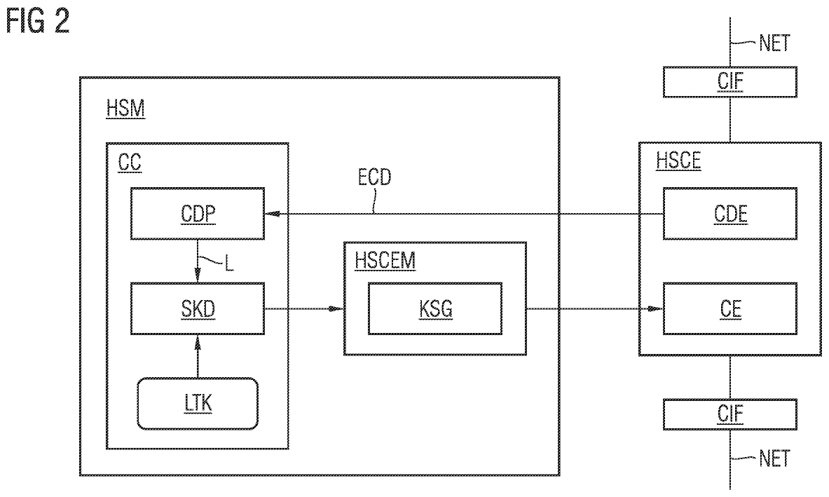

In the exemplary embodiment shown in FIG. 2, the session key is not transferred to the cryptography module CE directly from the module SKD for defining a session key, but instead the session key is transferred in each case to a separate high-speed cryptography module HSCEM of the encryption apparatus HSM, which produces a key-datastream by the session key. This key-datastream is then transferred to the high-speed decryption module HSCE, which in turn transfers the key-datastream to the cryptography module CDE of the high-speed decryption module HSCE. The exemplary embodiment shown in FIG. 2 otherwise corresponds to the exemplary embodiment shown in FIG. 1. In principle, the key-datastream of FIG. 2 can also be regarded as a second, continuously generated session key within the meaning of the invention, which is derived from the long-term key.

The plaintext plausibility-verification unit CDP in the session key generator CC in this case works as follows: The plausibility of the portion ECD of the plaintext is verified by, for example, checking a CRC checksum or a cryptographic checksum or an embedded watermark of the plaintext, in particular a cryptographic watermark. In some embodiments, a subject of the plausibility verification is an intended usage context of a session key, for example a usage time period defined for the session key, or identification information from a sender and/or receiver of the portion ECD of the plaintext, or a format of the portion ECD of the plaintext. Thus the plausibility verification can comprise checking whether the decrypted data is a valid safety message of a safety protocol, for instance contains a current time stamp and has a valid CRC safety checksum. In addition, the plausibility verification can comprise checking a series of decrypted messages, for example a check for a match of received decrypted data with sent encrypted data. The presence of watermarks can be checked by means of a bit operation, for example by means of a bitwise comparison, or by using pattern recognition algorithms, for example by a principal component analysis or by a neural network or by signal processing algorithms, for example by filtering or correlation or convolution or a transform, for instance the fast Fourier transform, or by determining and checking statistical parameters such as the mean and variance. This involves examining whether the provided portion ECD of the plaintext data contains expected data from a watermark.

1. An apparatus for receiving cryptographically protected communication data, the apparatus comprising:
a key generator for generating session keys;
a receive module with a signal link to the key generator and configured to receive and decrypt cryptographically protected communication data into plaintext information using the session keys; and
a check module with a signal link to the receive module and configured to subject the plaintext information to a check for context information characterizing a communication context of the encrypted communication data;
wherein the apparatus restricts action of the receive module depending on a result of the check.

2. The apparatus as claimed in claim 1, wherein the communication context depends on the session key.

3. The apparatus as claimed in claim 1, wherein:
a portion of the plaintext information is transferred to the check module; and
the check module subjects the portion of the plaintext information to the check.

4. The apparatus as claimed in claim 1, wherein the context information comprises at least one of: information about a usage time period, or identification information from sender and/or receiver, a format of the cryptographic communication data and/or of the plaintext information, compliance of the plaintext information with a protocol, and/or a validity of a time stamp or of a check value.

5. The apparatus as claimed in claim 1, wherein the context information comprises a watermark.

6. The apparatus as claimed in claim 1, wherein the context information comprises at least one checksum.

7. The apparatus as claimed in claim 1, wherein:
send-information is converted into encrypted send-data using session keys generated and transferred by the session key generator; and
the apparatus is designed to check the encryption of the send-data by means of session keys.

8. The apparatus as claimed in claim 1, wherein the apparatus comprises a mobile radio device.

9. The apparatus as claimed in claim 1, wherein the apparatus comprises an industrial Internet of Things device configured to receive encrypted communication data in the form of control information and/or safety protocol information.

10. A method for receiving cryptographically protected communication data, the method comprising:
using a key generator to generate session keys;
receiving and decrypting cryptographically protected communication data through a receive module with a signal link to the key generator into plaintext information using the session keys;
subjecting the plaintext information subjected to a check for context information characterizing a communication context of the encrypted communication data; and
restricting the receiving or the decryption depending on a result of the check.
